(19) United States
(12) Patent Application Publication
(10) Pub. No.: US 2026/0292661 A1
(43) Pub. Date: Sep. 24, 2026

(54) MANAGING WIRELESS COMMUNICATION CHANNELS USING INTERMEDIARY DEVICES

(71) Applicant: Google LLC, Mountain View, CA (US)

(72) Inventors: Salil Rajadhyaksha, Mountain View, CA (US); Arthur Tiv, San Jose, CA (US); Igor Zaslavsky, San Jose, CA (US)

(21) Appl. No.: 19/564,389

(22) Filed: Mar. 12, 2026

Related U.S. Application Data
(60) Provisional application No. 63/775,087, filed on Mar. 20, 2025.

(51) Int. Cl. H04W 48/10; H04W 48/16; H04W 76/19

(52) U.S. Cl. CPC H04W 48/10; H04W 48/16; H04W 76/19

(57) ABSTRACT

An example method includes receiving, by a first computing device, a request to initiate wireless communication protocol advertisement message broadcasts, the request to initiate wireless communication protocol advertisement message broadcasts is transmitted to the first computing device in response to a computing system receiving a discoverability request initiated by a second computing device. The method also includes, responsive to receiving the request to initiate wireless communication protocol advertisement message broadcasts, broadcasting, by the first computing device, one or more advertisement messages, where the one or more advertisement messages enable wireless communication channel initialization between the second computing device and the first computing device.

### CROSS-REFERENCE TO RELATED APPLICATIONS

This application claims the benefit of US Provisional Patent Application No. 63/775,087, filed 20 Mar. 2025, the entire contents of which are incorporated herein by reference.

### BACKGROUND

Computing devices, including wearable devices and mobile devices, frequently communicate with other devices using wireless communication channels. To establish a wireless communication channel, the initiating device transmits a discovery request to identify available peers within range. The receiving device may respond with an acknowledgment, probe request, or connection request. Once both devices detect each other, the devices may perform authentication and association techniques, followed by negotiating connection parameters before entering into an active communication state.

### SUMMARY

In general, aspects of this disclosure are directed to techniques for initializing wireless communication between two devices. For example, a tablet may send a request to discover nearby devices to a cloud computing service. The request may include a device or account identifier (e.g., an account ID, a user ID, device ID, etc.). The cloud computing service may identify other devices associated with the tablet or a user who is logged into the tablet based on the device, user, or account identifier. The cloud computing service may cause one or more of the other devices that are not already connected to the tablet to start broadcasting a wireless protocol advertisement message (e.g., Bluetooth Low Energy or other wireless network protocol). For example, a user may have a watch that is not currently paired or otherwise connected to the tablet. The tablet, using the cloud computing service, may cause the watch to start broadcasting the advertisement message. After receiving the broadcast message, the tablet may establish an initial connection with or reconnect to the watch. In this way, the tablet may automatically connect to devices of the user account without the user having to initiate a pairing process.

If the tablet loses connection with the watch, the tablet may send a reconnection request to the cloud computing service for transmission to a phone. After receiving the reconnection request, the phone may decide whether the tablet and watch are within a close enough distance to each other to reinitiate wireless communication. Because the phone is wirelessly connected to the watch, the phone may use the phone’s position when calculating a distance to the tablet. For example, the phone may compare the phone’s location information or local network information with the tablet’s information. If the tablet and phone are within a close enough distance to each other, the phone may transmit a request to begin advertisement broadcasts to the watch. In response, the watch may again begin broadcasting advertisement messages for the tablet. In this way, the watch conserves energy by broadcasting advertisement messages only when the watch is within a threshold distance to the tablet.

In one example, the disclosure is directed toward a method that includes receiving, by a first computing device (which may be a peripheral device), a request to initiate wireless communication protocol advertisement message broadcasts. The request to initiate wireless communication protocol advertisement message broadcasts is transmitted to the first computing device in response to a computing system (which may be a cloud system) receiving a discoverability request from a second computing device (which may be a central device, e.g., a Bluetooth Low Energy central device). The method also includes, responsive to receiving the request to initiate wireless communication protocol advertisement message broadcasts, broadcasting, by the first computing device, one or more advertisement messages, where the one or more advertisement messages enable wireless communication channel initialization between the second computing device and the first computing device.

In another example, the disclosure is directed toward a computing system comprising one or more processors, and one or more storage devices that store instructions. The instructions, when executed by the one or more processors, cause the one or more processors to receive, at a first computing device, a request to initiate wireless communication protocol advertisement message broadcasts. The request to initiate wireless communication protocol advertisement message broadcasts being transmitted to the first computing device in response to a cloud system receiving a discoverability request initiated by a second computing device. The instructions further cause the one or more processors to, responsive to receiving the request to initiate wireless communication protocol advertisement message broadcasts, broadcast, from the first computing device, one or more advertisement messages, where the one or more advertisement messages enable wireless communication channel initialization between the second computing device and the first computing device.

In another example, the disclosure is directed toward a non-transitory computer-readable storage medium encoded with instructions that, when executed by one or more processors, cause one or more processors to receive, at a first computing device, a request to initiate wireless communication protocol advertisement message broadcasts. The request to initiate wireless communication protocol advertisement message broadcasts is transmitted to the first computing device in response to a cloud system receiving a discoverability request initiated by a second computing device. The instructions further cause the one or more processors to, responsive to receiving the request to initiate wireless communication protocol advertisement message broadcasts, broadcast, from the first computing device, one or more advertisement messages, where the one or more advertisement messages enable wireless communication channel initialization between the second computing device and the first computing device.

In another example, the disclosure is directed toward a computer program product for communicating across computing elements. The computer program product comprises one or more instructions that, when executed by at least one processor, cause the at least one processor to receive, at a first computing device, a request to initiate wireless communication protocol advertisement message broadcasts. The request to initiate wireless communication protocol advertisement message broadcasts is transmitted to the first computing device in response to a cloud system receiving a discoverability request initiated by a second computing device. The one or more instructions further cause the at least one processor to, responsive to receiving the request to initiate wireless communication protocol advertisement message broadcasts, broadcast, from the first computing device, one or more advertisement messages, where the one or more advertisement messages enable wireless communication channel initialization between the second computing device and the first computing device.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram illustrating an example network of computing elements, in accordance with one or more aspects of this disclosure.

FIG. 2 is a conceptual diagram illustrating an example computing device in wireless communication with other computing elements, in accordance with one or more aspects of this disclosure.

FIG. 3 is a conceptual diagram illustrating an example network of computing elements configured to perform computing system-triggered computing device discoverability techniques, in accordance with one or more aspects of this disclosure.

FIG. 4 is a conceptual diagram illustrating an example network of computing elements configured to perform computing system-assisted communication reconnection techniques, in accordance with one or more aspects of this disclosure.

FIG. 5 is a swimlane diagram illustrating an example operation for establishing a wireless communication channel, in accordance with one or more aspects of this disclosure.

FIG. 6 is a flowchart illustrating an example operation for establishing a wireless communication channel, in accordance with one or more aspects of this disclosure.

### DETAILED DESCRIPTION

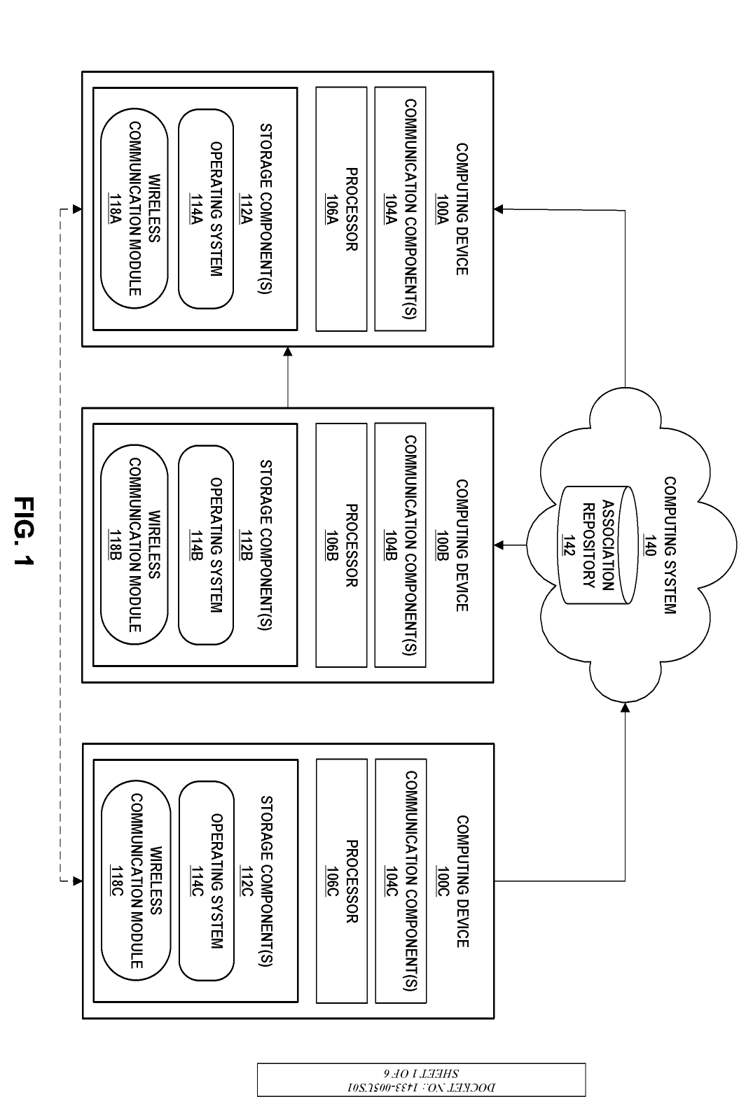

FIG. 1 is a conceptual diagram illustrating an example network of computing elements, in accordance with one or more aspects of this disclosure. In the example of FIG. 1, computing devices 100A-C (collectively, “computing devices 100”) may each be an individual mobile or non-mobile computing device. Each of computing devices 100 may be a mobile phone, a tablet computer, a laptop computer, a desktop computer, a server, a mainframe, a set-top box, a television, a wearable device (e.g., a computerized watch, computerized eyewear, computerized headphones, computerized gloves, computerized ring, etc.), a home automation device or system (e.g., an intelligent thermostat or home assistant device), a gaming system, a media player, an e-book reader, a mobile television platform, an augmented reality device, a virtual reality device, a mixed reality device, an automobile navigation or infotainment system, or any other type of mobile, non-mobile, wearable device, or non-wearable device configured to manage wireless communication channels in accordance with techniques of this disclosure. In some implementations, computing device 100A may be a peripheral device, computing device 100B may be a companion (or proxy) device, and computing device 100C may be a central device. Computing devices 100 may implement various compute resources, e.g., processors, memory, data storage, data buses, input/output controllers, network interfaces, accelerators (e.g., graphics accelerators), and power management units.

One or more communication components 104 of computing devices 100 may communicate with external devices via one or more wired and/or wireless networks by transmitting and/or receiving network signals on the one or more networks. Examples of communication components 104 include network interface cards (e.g., Ethernet cards), optical transceivers, radio frequency transceivers, global positioning system (GPS) receivers, or any other device that can send and/or receive information. Other examples of communication components 104 may include short wave radios, cellular data radios, wireless network radios, as well as universal serial bus (USB) controllers.

Processors 106 may implement functionality and/or execute instructions within computing devices 100. For example, each processor of processors 106 may be a central processing unit (CPU), graphics processing unit (GPU), application processor (AP), digital signal processor (DSP), neural processing unit (NPU), image signal processor (ISP), or microcontroller unit (MCU). Processors 106 may implement computational components including arithmetic logic units, control units, registers, pipelines, execution cores, caches (e.g., L1, L2, and L3), and branch predictors. Processors 106 may operate based on a fetch-decode-execute cycle, where processors 106 retrieve instructions from memory, decode the instructions into operations, and execute the instructions via various functional units. Further, processors 106 may implement an instruction set that defines software and hardware communication at a binary level. In some implementations, processors 106 may include multiple cores and may support multiple threads, and may perform techniques including parallel processing, graphics rendering, and multimedia processing.

Processors 106 may execute program code associated with operating systems 114 and/or wireless communication modules 118. Operating systems 114 and wireless communication modules 118 may perform operations described herein using software, hardware, firmware, or a mixture of hardware, software, and firmware residing in and/or executing at computing devices 100 or processors 106. In some implementations, processors 106 may execute operating systems 114 and wireless communication modules 118 as virtual machines executing on underlying hardware, as one or more services of an operating system or computing platform, and/or as one or more executable programs at an application layer of processors 106.

Computing devices 100 may write data to or read data from one or more storage components 112, where storage components 112 may store execution code associated with operating systems 114 and wireless communication modules 118. Storage components 112 may each include one or more hard disk drives, solid-state drives, hybrid drives, removable media drives, optical drives, and/or any other device configured to store information. In some implementations, storage components 112 may be configured for short-term storage of information as volatile memory and therefore may not retain stored contents if powered off. Examples of volatile memories include random access memory (RAM), dynamic random-access memory (DRAM), and static random-access memory (SRAM).

Operating systems 114 manage hardware resources and may provide platforms for software execution at processors 106. Operating systems 114 may perform scheduling algorithms (e.g., round-robin and multilevel queues), allocate memory via virtual memory management and paging mechanisms, and facilitate interprocess communication (IPC) via message queues, pipes, and shared memory. Operating systems 114 may implement preemptive multitasking, real-time scheduling for deterministic latency, and dynamic power management to improve performance and power consumption of processors 106.

Wireless communication modules 118 may manage wireless communication between each of computing devices 100, as well as communication with other computing elements, e.g., computing system 140. In some implementations, wireless communication modules 118 may establish and maintain communication channels using protocols associated with Wi-Fi, Bluetooth, and/or cellular networking (e.g., Long Term Evolution (LTE), 5G). Wireless communication modules 118 may implement communication components 104 to send and receive wireless signals, and may use adaptive frequency selection, power control, and error correction techniques to improve signal integrity and transmission output based on network conditions.

Computing system 140 may be a system or network of computing devices configured to provide services to other devices. For example, computing system 140 may be a cloud system that provides computing services, storage services, networking services, database services, and/or application hosting services to one or more of computing device 100A, computing device 100B, and computing device 100C. Computing system 140 may include distributed computing resources managed by virtualization technologies, container orchestration platforms, and/or serverless computing frameworks. Additionally, computing system 140 may use load balancing, fault tolerance, and redundancy techniques to increase system availability.

Computing system 140 may host association repository 142. Association repository 142 may be a database or application associating two or more computing devices. In some implementations, association repository 142 may group computing devices based on a device identifier. For example, computing device 100A, computing device 100B, and computing device 100C may each be associated with a device identifier, where association repository 142 indicates that the respective device identifier belongs to a common group of device identifiers. In this way, computing system 140 may receive a device identifier and, based on the device identifier, identify a set of computing devices associated with the device identifier. Additionally, or alternatively, association repository 142 may group devices belonging to a user account. To ensure security and proper identity management, association repository 142 may utilize account-specific certificates shared between the computing devices 100 and computing system 140. These certificates may be managed via a platform-agnostic software development kit (SDK) (e.g., Nearby Presence) that allows devices to recognize each other's state and capabilities securely. Computing system 140 may use these certificates to verify that the computing device 100C and computing device 100A are signed in with the same account before forwarding any discoverability requests. In this way, computing system 140 may receive an account identifier (e.g., user information and/or a user account number) and, based on the account identifier, identify a set of computing devices associated with the account identifier.

According to various aspects of the present disclosure, computing device 100C may transmit an identifier to computing system 140. The identifier may be a device identifier (e.g., a sequence of characters that is unique to computing device 100C) and/or an account identifier (e.g., a username, password, and/or a sequence of characters that is unique to a user account). In some implementations, the transmission of the identifier and the request to initiate discoverability may be performed via a remote procedure call (RPC) invoked by the computing device 100C to the computing system 140. The computing system 140 acts as a secure server that validates the RPC against registered identities before processing the command. In some implementations, computing device 100C may also transmit an indication of a target device that should transmit advertisement message broadcasts, e.g., an indication of computing device 100A.

After receiving the identifier, computing system 140 may use association repository 142 to determine a set of devices associated with the identifier. For example, association repository 142 may include a table associating a device ID of computing device 100C with other devices, e.g., computing device 100B and/or computing device 100A. Additionally, or alternatively, association repository 142 may include a table that lists a set of devices associated with a user account, where computing device 100C is one device of the set of devices. In some implementations, computing system 140 may determine the set of devices based on an indication received from computing device 100C, where the indication identifies (e.g., via a device identifier) computing device 100A.

After determining the set of devices associated with the identifier, computing system 140 may transmit a request to initiate wireless communication protocol advertisement message broadcasts to one or more of the devices associated with the identifier. For example, computing system 140 may determine that computing device 100A and computing device 100B are associated with computing device 100C via the identifier. In this example, computing system 140 may transmit a request to initiate wireless communication protocol advertisement message broadcasts to computing device 100A and/or computing device 100B. In some examples, computing system 140 may transmit the request to one or more of computing device 100A and computing device 100B based on determining that computing system 140 is wirelessly connected to computing device 100A and/or computing device 100B.

In some implementations, the contents of the request to initiate wireless communication protocol advertisement message broadcasts may be based on an intended recipient. For example, if computing system 140 transmits the request to computing device 100A, the request may include instructions that computing device 100A initiate wireless communication protocol advertisement message broadcasts. If computing system 140 transmits the request to computing device 100B, the request may include instructions that computing device 100B transmit a request to initiate wireless communication protocol advertisement message broadcasts to computing device 100A, the request to initiate wireless communication protocol advertisement message broadcasts instructing computing device 100A to initiate wireless communication protocol advertisement message broadcasts.

In still some implementations, computing system 140 may transmit the request to initiate wireless communication protocol advertisement message broadcasts to computing device 100A and/or computing device 100B, where the requests’ contents are the same regardless of recipient. For example, computing system 140 may transmit a request to initiate wireless communication protocol advertisement message broadcasts to computing device 100A and/or computing device 100B, where the request indicates that computing device 100A is instructed to initiate wireless communication protocol advertisement message broadcasts. After receiving the request, wireless communication module 118B may determine that computing device 100B is wirelessly connected to computing device 100A. Based on wireless communication module 118B determining that computing device 100B is wirelessly connected to computing device 100A, computing device 100B may transmit a request to initiate wireless communication protocol advertisement message broadcasts to computing device 100A, where the request indicates that computing device 100A is instructed to initiate wireless communication protocol advertisement message broadcasts.

In response to receiving the request to initiate wireless communication protocol advertisement message broadcasts from either computing system 140 or computing device 100B, computing device 100A may transmit an advertisement message broadcast. For example, computing device 100A may transmit an advertisement message via Bluetooth to nearby devices, the message indicating availability for pairing. In this example, computing device 100A may periodically broadcast a Bluetooth Low Energy (BLE) advertisement packet including a device name, supported services, and a unique identifier to enable other computing devices to detect computing device 100A and initiate a wireless connection with computing device 100A.

In response to receiving the advertisement message broadcast, computing device 100C may initialize a wireless communication channel between computing device 100C and computing device 100A. For example, wireless communication module 118C may communicate with wireless communication module 118A to establish a wireless connection between computing device 100A and computing device 100C via Bluetooth. In this example, computing device 100C may transmit a connection request to computing device 100A and, responsive to receiving the connection request at computing device 100A, communication module 118A may establish a paired communication link with communication module 118C.

An example regarding FIG. 1 will now be provided. In this example, a user owns a smartwatch, smartphone, and a tablet. The smartwatch may be computing device 100A, the smartphone may be computing device 100B, and the tablet may be computing device 100C. The user, wishing to pair the smartwatch with the tablet via Bluetooth, initiates a discovery process via an application or operating system component of the tablet. For instance, the user may be attempting to utilize a 'Watch to Tablet' unlock feature, where the proximity of the authenticated smartwatch (computing device 100A) is required to unlock the tablet (computing device 100C). In this scenario, the tablet initiates the discovery process automatically to verify the presence of the watch without requiring the user to manually interact with the watch to make it discoverable. In response, the tablet may transmit a message to a cloud system (e.g., computing system 140) via an internet connection or cellular connection, where the message includes account information of the user. The cloud system may then determine, based on the account information, that the smartphone and smartwatch are associated with the same user account as the tablet. Based on this determination, the cloud system may transmit a broadcast request (e.g., a request that the smartwatch initiate wireless communication protocol advertisement message broadcasts) to the smartwatch and/or smartphone via an internet connection or cellular connection.

Responsive to receiving the broadcast request, the smartphone may forward the broadcast request to the smartwatch via a Bluetooth connection between the smartphone and smartwatch. The smartwatch, in response to receiving the broadcast request from either the smartphone or the cloud system, may initiate a discoverable mode by broadcasting Bluetooth advertisements. The tablet may then receive a Bluetooth advertisement and, in response, initiate a pairing procedure between the tablet and the smartwatch. Once the tablet and smartwatch are paired, the tablet and smartwatch may then send and receive data to each other via Bluetooth messages. In this way, the user can wirelessly connect the tablet to the smartwatch without the smartwatch having to remain in an advertisement broadcasting state or the user having to manually initiate advertisement broadcasts on the smartwatch.

Because other devices (e.g., computing device 100C) may wirelessly connect to computing device 100A without computing device 100A remaining in an advertisement broadcasting state, computing device 100A may conserve compute resources. For example, some techniques include periodically transmitting advertisement message broadcasts from an advertising device regardless of whether other devices indicate instructions to wirelessly connect with the advertising device. Because computing device 100A may only transmit advertisement message broadcasts responsive to receiving a broadcast request, computing device 100A therefore may conserve significant battery power, processor utilization, and bandwidth associated with transmitting periodic advertisement message broadcasts.

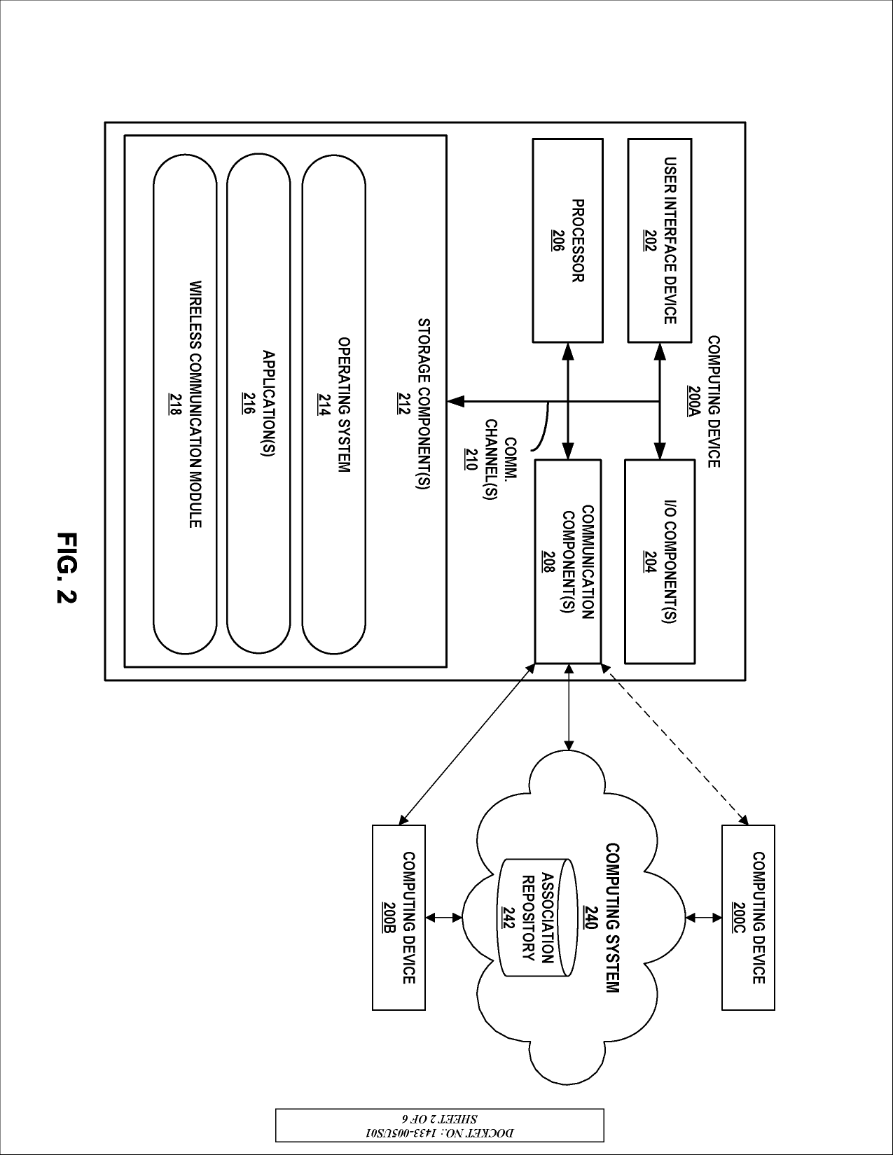

FIG. 2 is a conceptual diagram illustrating an example computing device in wireless communication with other computing elements, in accordance with one or more aspects of this disclosure. FIG. 2 includes computing devices 200A-C (collectively, “computing devices 200”), where each device of computing devices 200 may be an individual mobile or non-mobile computing device. For example, computing devices 200 may include one or more of a mobile phone, a tablet computer, a laptop computer, a desktop computer, a server, a mainframe, a set-top box, a television, a wearable device (e.g., a computerized watch, computerized eyewear, computerized headphones, computerized gloves, computerized ring, etc.), a home automation device or system (e.g., an intelligent thermostat or home assistant device), a gaming system, a media player, an e-book reader, a mobile television platform, an augmented reality device, a virtual reality device, a mixed reality device, an automobile navigation or infotainment system, or any other type of mobile, non-mobile, wearable device, or non-wearable device configured to communicate with other computing elements in accordance with techniques of this disclosure. In some implementations, computing device 200A may be a peripheral device, computing device 200B may be a companion (or proxy) device, and computing device 200C may be a central device. Computing devices 200 may implement various compute resources, including processors, memory, data storage, data buses, input/output controllers, network interfaces, accelerators (e.g., graphics accelerators), and power management units.

Computing device 200A includes user interface (UI) device 202. UI device 202 may function as an input and/or output device for computing device 200A and may be implemented using various technologies. For instance, UI device 202 may function as an input device using a presence-sensitive display, microphone technologies, infrared sensor technologies, or other input device technology for use in receiving user input. UI device 202 may function as an output device configured to present output to a user using any one or more display devices (e.g., a presence-sensitive display), speaker technologies, haptic feedback technologies, or other output device technology for use in outputting information to a user. In some implementations, UI device 202 may be a component of input/output (I/O) components 204.

One or more I/O components 204 may receive input and/or provide output for computing device 200A. I/O components 204 may provide output by, for example, making information perceivable to an external component or user. I/O components 204 may convert data produced by computing device 200A into a user-understandable or machine-interpretable format, e.g., a visual, audio, or physical format. Examples of output components of I/O components 204 include audio output devices (e.g., speakers and headphones), haptic output devices, printers, actuators, network interfaces, and storage devices. I/O components 204 may also provide input for computing device 200A by, for example, converting external signals into machine-readable formats. Examples of input components of I/O components 204 include game controllers, audio input devices (e.g., microphones), image input devices (e.g., cameras and scanners), thermometers, accelerometers, motion detectors, biometric devices, network interfaces, rotating crown buttons, push buttons, and storage devices.

Processor 206 may implement functionality and/or execute instructions within computing device 200A. For example, processor 206 may be a CPU, GPU, AP, DSP, NPU, ISP, or MCU. Processor 206 may implement computational components including arithmetic logic units, control units, registers, pipelines, execution cores, caches (e.g., L1, L2, and L3), and branch predictors. Processor 206 may operate based on a fetch-decode-execute cycle, where processor 206 retrieves instructions from memory, decodes the instructions into operations, and executes the instructions via various functional units. Further, processor 206 may implement an instruction set that defines software and hardware communication at a binary level. In some implementations, processor 206 may include multiple cores and may support multiple threads, and may perform techniques including parallel processing, graphics rendering, and multimedia processing.

One or more communication components 208 of computing device 200A may communicate with external devices via one or more wired and/or wireless networks by transmitting and/or receiving network signals on the one or more networks. Examples of communication components 208 include network interface cards (e.g., Ethernet cards), optical transceivers, radio frequency transceivers, GPS receivers, or any other type of device that can send and/or receive information. Other examples of communication components 208 may include short wave radios, cellular data radios, wireless network radios, as well as USB controllers.

Communication channels 210 may interconnect each of UI device 202, communication components 208, processor 206, I/O components 204, and storage components 212 for inter-component communication (physically, communicatively, and/or operatively). In some examples, communication channels 210 may include a system bus, a network connection, an inter-process communication data structure, or any other method for communicating data.

Computing device 200A may write data to or read data from one or more storage components 212, where storage components 212 may store execution code and/or other data associated with operating system 214, applications 216, and wireless communication module 218. Storage components 212 may include one or more hard disk drives, solid-state drives, hybrid drives, removable media drives, optical drives, and/or any other device configured to store information. In some implementations, storage components 212 may be configured for short-term storage of information as volatile memory and therefore may not retain stored contents if powered off. Examples of volatile memories include RAM, DRAM, and SRAM.

Processor 206 may execute program code associated with one or more of operating system 214, applications 216, and wireless communication module 218. Operating system 214, applications 216, and wireless communication module 218 may perform operations described herein using software, hardware, firmware, or a mixture of hardware, software, and firmware residing in and/or executing at computing device 200A or processor 206. In some implementations, processor 206 may execute operating system 214, applications 216, and wireless communication module 218 as virtual machines executing on underlying hardware, as one or more services of an operating system or computing platform, and/or as one or more executable programs at an application layer of processor 206.

Operating system 214 manages hardware resources and may provide a platform for software execution at processor 206. Operating system 214 may perform scheduling algorithms (e.g., round-robin and multilevel queues), allocate memory via virtual memory management and paging mechanisms, and facilitate IPC via message queues, pipes, and shared memory. Operating system 214 may implement preemptive multitasking, real-time scheduling for deterministic latency, and dynamic power management to improve performance and power consumption of processor 206.

Applications 216 may be first-party, second-party, or third-party applications of computing device 200A. Applications 216 may extend software functionality of processor 206, where applications 216 may execute within an execution environment presented by operating system 214. Applications 216 may, as a few examples, provide gaming services (e.g., video games), email services, web browsing services, texting and/or chat services, web conferencing services, video conferencing services, music services (including streaming music services), video services (including video streaming services), navigation services, weather services, word processing services, spreadsheet services, slide and/or presentation services, assistant services, text entry services, network access services, or any other application service.

Wireless communication module 218 may manage wireless communication between computing device 200A and other computing elements e.g., computing device 200B, computing device 200C, and computing system 240. In some implementations, wireless communication module 218 may establish and maintain communication channels using protocols associated with Wi-Fi, Bluetooth (e.g., BLE and Bluetooth Classic), and/or cellular networking (e.g., LTE and 5G). Wireless communication module 218 may implement communication components 208 to send and receive wireless signals, and may use adaptive frequency selection, power control, and error correction techniques to improve signal integrity and transmission output based on network conditions.

Computing system 240 may be a system or network of computing devices configured to provide services to other devices. For example, computing system 240 may be a cloud system that provides computing services, storage services, networking services, database services, and/or application hosting services to one or more of computing device 200A, computing device 200B, and computing device 200C. Computing system 240 may include distributed computing resources managed by virtualization technologies, container orchestration platforms, and/or serverless computing frameworks. Additionally, computing system 240 may use load balancing, fault tolerance, and redundancy techniques to increase system availability.

Computing system 240 may host association repository 242. Association repository 242 may be a database or application associating two or more computing devices. In some implementations, association repository 242 may group computing devices based on a device identifier. For example, computing device 200A, computing device 200B, and computing device 200C may each be associated with a device identifier, where association repository 242 indicates that the respective device identifier belongs to a common group of device identifiers. In this way, computing system 240 may receive a device identifier and, based on the device identifier, identify a set of computing devices associated with the device identifier. Additionally, or alternatively, association repository 242 may group devices belonging to a user account. In this way, computing system 240 may receive an account identifier (e.g., user information and/or a user account number) and, based on the account identifier, identify a set of computing devices associated with the account identifier.

According to various aspects of the present disclosure, computing device 200A may receive a request to reinitiate wireless communication protocol advertisement message broadcasts. Computing device 200B may have transmitted the request based on receiving a reconnection request associated with computing device 200A and determining that a distance between computing device 200A and computing device 200C satisfies a proximity specification. For example, computing device 200A may establish a wireless communication channel with computing device 200C. A disruption event may then interfere with the wireless communication channel. For instance, computing device 200A may be taken outside of a maximum wireless range of communication components 208. Additionally, or alternatively, wireless communication module 218 may temporarily disable communication via the wireless communication channel.

In response to the disruption event interfering with the wireless communication channel, computing device 200A may transmit a reconnection request to computing system 240. The reconnection request may include an identifier associated with one or more devices of computing devices 200. Computing system 240 may transmit a subsequent reconnection request based on the identifier. For example, computing system 240 may transmit the request to computing device 200B responsive to the identifier identifying computing device 200B. Additionally, or alternatively, computing system 240 may transmit the request to computing device 200B responsive to the identifier identifying computing device 200C and computing system 240 determining that computing device 200B is associated with computing device 200C, e.g., that computing device 200B is or has been wirelessly connected to computing device 200C. In some implementations, computing system 240 may transmit the subsequent reconnection request to each device of a set of devices. Computing system 240 may determine the set of devices based on a user account associated with computing device 200A. For example, the set of devices may be one or more devices assigned to the user account.

Responsive to receiving the subsequent reconnection request, computing device 200B may determine whether a distance between computing device 200A and computing device 200C satisfies a proximity specification. Computing device 200B may transmit the request to reinitiate wireless communication protocol advertisement message broadcasts to computing device 200A based on determining that the distance satisfies the proximity specification. Because computing device 200A may be wirelessly connected to computing device 200B, computing device 200B may determine the distance between computing device 200A and computing device 200C by comparing the distance between computing device 200B and computing device 200C. For example, computing device 200B may transmit the request to reinitiate wireless communication protocol advertisement message broadcasts based on comparing location information (e.g., GPS data) of computing device 200C with location information of computing device 200B. Computing device 200B may determine that the distance between computing device 200A and computing device 200C satisfies the proximity specification if the location information of computing device 200B and computing device 200C indicates that computing device 200B is within a threshold distance of computing device 200C, e.g., 30 meters.

In some implementations, the location information may indicate a general geographic location, e.g., a geographic landmark, street, postal address, building, story of a building, or room within a building. For instance, the location information of computing device 200B may indicate that computing device 200B is at Building ABC. The location information of computing device 200C may indicate that computing device 200C is at ABC Park. Computing device 200B may determine that the distance satisfies the proximity specification if the geographic location of computing device 200B and the geographic location of computing device 200C indicate that computing device 200B is within a threshold distance of computing device 200C. In this example, computing device 200B may use navigation data to determine that the proximity specification is satisfied based on determining that Building ABC is within a threshold distance to ABC Park. Computing device 200B may then transmit a request to reinitiate wireless communication protocol advertisement message broadcasts to computing device 200A based on comparing the location information and determining that the distance between computing device 200A and computing device 200C satisfies the proximity specification.

Responsive to receiving the request to reinitiate wireless communication protocol advertisement message broadcasts, computing device 200A may transmit a subsequent advertisement message broadcast enabling wireless communication channel initialization (e.g., BLE or Bluetooth Classic communication channel initialization) between computing device 200A and computing device 200C. Computing device 200A and computing device 200C may then initialize a wireless communication channel between computing device 200A and computing device 200C. In some implementations, computing device 200A and computing device 200C may initialize the wireless communication channel by reinitializing a previous wireless communication channel. Additionally, or alternatively, computing device 200A and computing device 200C may initialize a wireless communication channel by initializing a new wireless communication channel.

In some implementations, computing device 200B may transmit, to computing device 200A, a request to stop wireless communication protocol advertisement message broadcasts. Computing device 200B may transmit the request based on determining that the distance between computing device 200A and computing device 200C exceeds a proximity threshold. For example, computing device 200B may compare location information of computing device 200B with location information of computing device 200C and determine that the distance between computing device 200B and computing device 200C exceeds the proximity threshold. Based on this determination, computing device 200B may transmit the request to stop wireless communication protocol advertisement message broadcasts to computing device 200A and, in response to receiving the request, computing device 200A may stop transmitting advertisement message broadcasts or may increase an interval at which computing device 200A transmits advertisement message broadcasts. In this way, computing device 200A may conserve battery power by not transmitting advertisement message broadcasts when computing device 200C is not within a range to receive such broadcasts.

Computing device 200B may transmit an escalation indication to computing device 200A based on determining that computing device 200B has moved. For example, computing device 200B may receive sensor data from sensors of computing device 200B, e.g., one or more accelerometers, gyroscopes, magnetometers, radio sensors, and/or proximity sensors. Based on this sensor data, computing device 200B may determine that computing device 200B has moved and may transmit the escalation indication to computing device 200A. For instance, a user may transport computing device 200B to another location, causing computing device 200B to transmit the escalation indication. The escalation indication may be data indicating that computing device 200B has moved and/or instructing computing device 200A to decrease an advertisement message broadcast interval or increase a broadcast power. Responsive to receiving the escalation indication, computing device 200A may begin transmitting advertisement message broadcasts, decreasing an advertisement message broadcast interval, and/or increasing an advertisement message broadcast power. For example, computing device 200A may decrease the advertisement message broadcast interval from 200 milliseconds to 100 milliseconds, causing computing device 200A to transmit advertisement message broadcasts more frequently.

In some implementations, computing device 200A may determine that a duration since transmitting the one or more advertisement messages exceeds a duration threshold e.g., 20 seconds. In response to determining that the duration exceeds the duration threshold, computing device 200A may increase an advertisement message broadcast interval and/or decrease an advertisement message broadcast power. For example, computing device 200A may determine that 20 seconds has elapsed since first transmitting an advertisement message broadcast in response to a request to initiate advertisement message broadcasts. Because the duration threshold in this example is 20 seconds, computing device 200A may increase the advertisement message broadcast interval and/or decrease the advertisement message broadcast power.

Similarly, computing device 200A may determine that the duration since transmitting the one or more advertisement messages exceeds a second duration threshold e.g., 30 seconds. In response to determining that the duration exceeds the second duration threshold, computing device 200A may increase the advertisement message broadcast interval and/or decrease the advertisement message broadcast power. For example, after computing device 200A decreased the broadcast interval and/or broadcast power based on the first duration threshold, computing device 200A may determine that 30 seconds has elapsed since first transmitting the one or more advertisement messages in response to the request to initiate advertisement message broadcasts. Because the second duration threshold in this example is 30 seconds, computing device 200A may increase the advertisement message broadcast interval and/or decrease the advertisement message broadcast power.

In some implementations, one or more of computing device 200A, computing device 200B, and computing device 200C may register an account identity with computing system 240. For example, an application of computing device 200B may prompt a user to provide user information, e.g., a name, email address, and/or phone number. After receiving the user information, computing device 200B may transmit account information to computing system 240. The account information may include the user information. The account information may include other information regarding computing device 200B, the user, or a user account associated with the user. For instance, the account information may include device identification information and/or a username and password. After receiving the account information, computing system 240 may store the account information via association repository 242.

It is conceived that a first computing device may register an account identity on behalf of a second computing device. For example, computing device 200A may be a smartwatch while computing device 200B may be a smartphone. After a user purchases and unboxes the smartwatch, the smartwatch may prompt the user to complete a setup process on the smartphone. The user may provide user information to the smartphone, and the smartphone may then upload account information to computing system 240, where the account information includes the user information and details regarding the smartwatch and/or smartphone, e.g., device identification information. Computing system 240 may then store the account information via association repository 242.

According to various aspects of the present disclosure, computing system 240 may use association repository 242 to determine that a set of computing devices is associated with one or more of computing devices 200. For example, computing system 240 may determine that a set of computing devices is associated with computing device 200C based on a user account associated with computing device 200C. Association repository 242 may store information related to the user account, including device information for devices associated with the account. In response to receiving user account information, computing system 240 may use the user account information to search association repository 242 and determine, based on the user account, the set of devices associated with the account.

In response to computing system 240 determining the set of devices associated with computing device 200C, computing system 240 may transmit, or cause to be transmitted via the set of devices, a request to initiate wireless communication protocol advertisement message broadcasts to one or more of the set of devices. In one example, the set of devices associated with computing device 200C includes computing device 200A and computing device 200B. Computing system 240 may therefore transmit the request to initiate wireless communication protocol advertisement message broadcasts to computing device 200A and/or computing device 200B. Furthermore, computing system 240 may transmit instructions to a subset of the set of devices, where the instructions instruct or otherwise cause the subset of devices to transmit a request to initiate wireless communication protocol advertisement message broadcasts to one or more other devices of the set of devices. For example, computing system 240 may receive account information from computing device 200C and, based on the account information, determine that computing device 200A and computing device 200B are associated with computing device 200C. Computing system 240 may then transmit instructions to computing device 200B, where the instructions instruct or otherwise cause computing device 200B to transmit a request to initiate wireless communication protocol advertisement message broadcasts to computing device 200A.

As discussed, computing device 200C may transmit a discoverability request to computing system 240, where computing system 240 may transmit a request to initiate wireless communication protocol advertisement message broadcasts to a set of devices based on receiving the discoverability request. In some implementations, computing system 240 may determine the set of devices based on contextual information associated with the device that transmitted the discoverability request. For instance, in response to receiving a discoverability request from computing device 200C, computing system 240 may determine a set of devices associated with computing device 200C based on metadata labels of the discoverability request. The metadata labels may identify computing device 200C and/or a user account associated with computing device 200C. Computing system 240 may then determine the set of devices by identifying devices associated with computing device 200C and/or the user account associated with computing device 200C.

Computing device 200C may initiate a timer associated with a discovery request. Computing device 200C may determine that the timer has expired prior to establishing the wireless communication channel with computing device 200A. In response to determining that the timer has expired, computing device 200C may display a UI via a UI device. The UI may present instructions prompting a user to manually enable a discoverable mode on computing device 200A.

Computing device 200C may generate geofence data defining a geographic boundary associated with a location of computing device 200C. Computing device 200C may transmit the geofence data to computing device 200B via computing system 240. Computing device 200B may store the geofence data. Additionally, computing device 200B may obtain location data from sensors of computing device 200B. Computing device 200B may determine whether the location data indicates that computing device 200B is located within the geographic boundary defined by the geofence data. In response to determining that computing device 200B is located within the geographic boundary, computing device 200B may transmit the request to reinitiate wireless communication protocol advertisement message broadcasts to computing device 200A.

Computing device 200C may modify a scanning duty cycle associated with detecting the one or more advertisement messages based on an operational state of computing device 200C. For example, computing device 200C may operate a wireless communication module according to a first scanning duty cycle in response to determining that a display of computing device 200C is in an inactive state. Computing device 200C may operate the wireless communication module according to a second scanning duty cycle in response to determining that the display of computing device 200C is in an active state. Additionally, or alternatively, computing device 200C may operate the wireless communication module according to the second scanning duty cycle in response to determining that computing device 200C is connected to a docking station or a power source. The second scanning duty cycle may attempt to verify the presence of the one or more advertisement messages more or less frequently than the first scanning duty cycle.

Computing device 200B may receive network information identifying a local network associated with computing device 200C and may store the network information in storage components. Computing device 200B may subsequently detect a change in a network connection status of computing device 200B. In response to detecting the change in the network connection status, computing device 200B may compare a current local network of computing device 200B with the network information stored in storage components. In response to a determination that the current local network matches the network information, computing device 200B may transmit the request to reinitiate wireless communication protocol advertisement message broadcasts to computing device 200A.

Computing system 240 may assign a priority level to the request to initiate wireless communication protocol advertisement message broadcasts. Computing system 240 may set the priority level to a high priority value in response to computing system 240 determining that computing device 200A operates in a power-saving mode. The high priority value may cause computing device 200A to exit the power-saving mode and process the request to initiate wireless communication protocol advertisement message broadcasts immediately. Computing system 240 may transmit the request to initiate wireless communication protocol advertisement message broadcasts via a cloud messaging service configured to deliver messages to computing device 200A regardless of a sleep state of computing device 200A.

Computing device 200B may implement a movement sensor (e.g., an accelerometer) to monitor the physical movement of a user associated with computing device 200B. Computing device 200B may determine that the user is moving based on movement data obtained from the movement sensor. In response to determining that the user is moving, computing device 200B may transmit the request to reinitiate wireless communication protocol advertisement message broadcasts to computing device 200A. Computing device 200B may determine that the movement data satisfies a movement threshold before transmitting the request to reinitiate wireless communication protocol advertisement message broadcasts. Additionally, or alternatively, in response to determining that the user is moving, computing device 200B may cause computing device 200A to adjust an advertisement message broadcast interval. Computing device 200B may determine that the movement data satisfies a movement threshold before causing computing device 200A to adjust the advertisement message broadcast interval. To cause computing device 200A to adjust the advertisement message broadcast interval, computing device 200B may transmit an interval adjustment indication to computing device 200A.

Computing device 200A may determine whether computing device 200A is worn by a user using, e.g., an accelerometer, a skin temperature sensor, an electrocardiogram sensor, or any other sensor that may indicate whether a user is wearing computing device 200A. For instance, computing device 200A may determine that a user is not wearing computing device 200A based on accelerometer data satisfying a threshold. Computing device 200A may restrict broadcasting of the one or more advertisement messages in response to determining that computing device 200A is not worn by the user. Computing device 200A may verify that computing device 200A is in an unlocked state prior to broadcasting the one or more advertisement messages. Computing device 200A may broadcast the one or more advertisement messages only in response to determining that computing device 200A is both worn by the user and in the unlocked state.

Computing device 200A may detect a disconnection of the wireless communication channel between computing device 200A and computing device 200C. In response to detecting the disconnection, computing device 200A may automatically initiate the broadcasting of the one or more advertisement messages. Computing device 200A may broadcast the one or more advertisement messages according to a first interval parameter. Computing device 200B may subsequently transmit the request to stop the wireless communication protocol advertisement message broadcasts to computing device 200A in response to determining that the distance between computing device 200A and computing device 200C exceeds the proximity threshold. In some implementations, computing device 200B may transmit a request to continue the wireless communication protocol advertisement message broadcasts in response to determining that the distance between computing device 200A and computing device 200C satisfies the proximity specification.

Computing device 200B may transmit a query to computing system 240 or computing device 200C to obtain network information associated with computing device 200C. Computing device 200B may transmit the query in response to computing device 200B detecting a change in a network connection status or in response to a reboot of computing device 200B. Computing device 200B may receive the network information in response to the query. Computing device 200B may utilize the network information to determine whether a distance between computing device 200A and computing device 200C satisfies the proximity specification.

Computing device 200A may implement a separate processing unit to manage the broadcasting of the one or more advertisement messages. The separate processing unit may operate independently of a main application processor of computing device 200A. The separate processing unit may execute a state machine that adjusts a broadcast interval based on a duration of time that has elapsed since a disconnection event. To conserve a battery resource of computing device 200A, the main application processor may enter a sleep state while the separate processing unit manages the broadcasting.

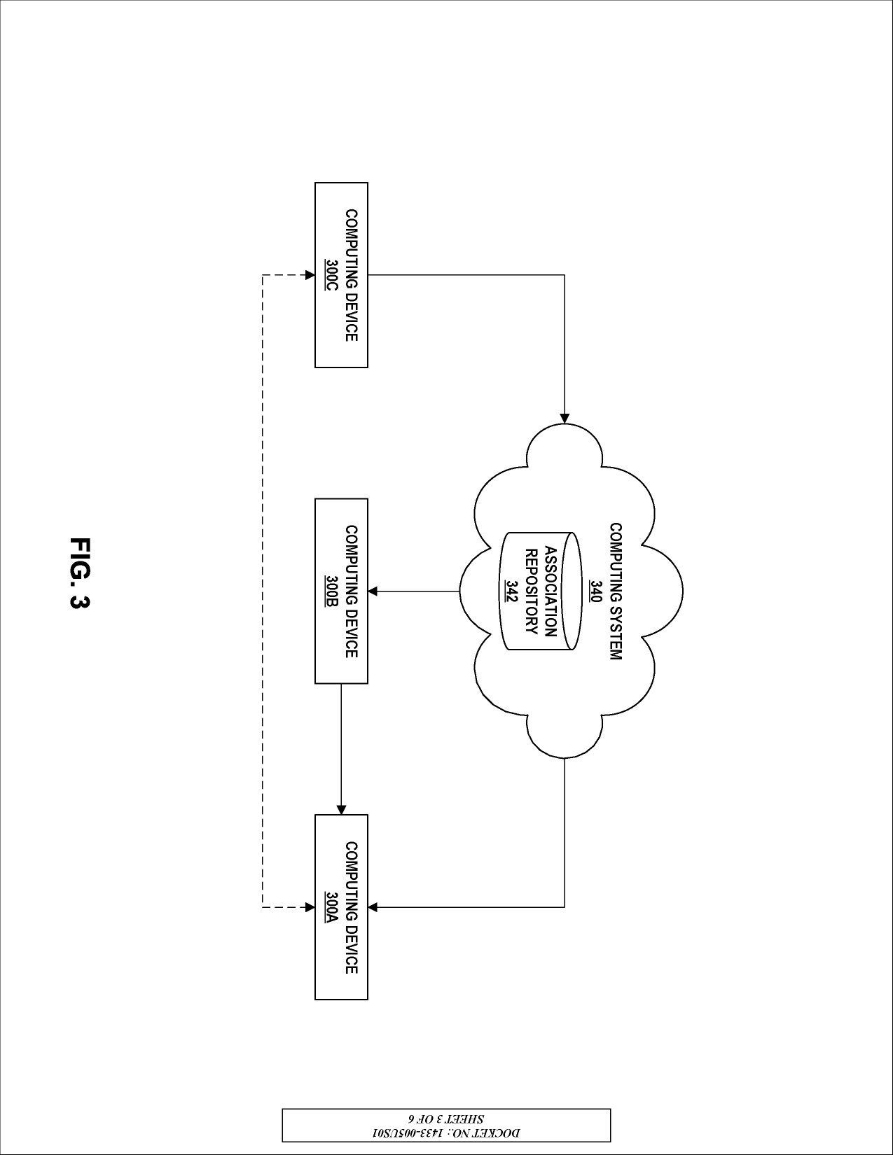

FIG. 3 is a conceptual diagram illustrating an example network of computing elements configured to perform computing system-triggered computing device discoverability techniques, in accordance with one or more aspects of this disclosure. As shown with respect to FIG. 3, computing device 300A, computing device 300B, and computing device 300C are in communication with computing system 340. In some implementations, computing device 300A may be a peripheral device, computing device 300B may be a companion (or proxy) device, and computing device 300C may be a central device. Computing system 340 includes association repository 342.

In some implementations, computing device 300C may transmit an identifier to computing system 340, where computing system 340 may be a cloud system. The identifier may include information indicating computing device 300C and/or computing device 300A. For example, the identifier may include a sequence of characters identifying computing device 300C. Additionally, or alternatively, the identifier may include account information. For example, the identifier may identify a user account stored at association repository 342. In this example, the identifier may include a user account identification number, a user password, and/or a username.

In response to receiving the identifier, computing system 340 may identify one or more computing devices via the identifier. For example, computing system 340 may compare information of the identifier with information stored at association repository 342. In some implementations, association repository 342 includes a database that groups computing devices. Computing system 340 may use the identifier to identify a group of computing devices including computing device 300C. Then, computing system 340 may identify other computing devices of the same group as computing device 300C. In still some implementations, association repository 342 includes a database of user accounts, where the database of user accounts indicates devices associated with each account. Computing system 340 may use the identifier to identify a user account. Then, computing system 340 may identify other computing devices also associated with the user account. Computing system 340 may identify a specific computing device indicated by the identifier. For example, a user account may be associated with five computing devices, where computing system 340 identifies one of the computing devices based on information of the identifier (e.g., a unique device identifier). Furthermore, computing system 340 may also identify computing devices by nature of the device’s association with a device indicated by the identifier. For example, the identifier may indicate computing device 300A. Computing system 340 may determine that computing device 300B is wirelessly connected to computing device 300A and may therefore identify both the indicated device (computing device 300A) and devices wirelessly connected to the indicated device (computing device 300B).

Computing system 340 may then initiate a request to initiate wireless communication protocol advertisement message broadcasts based on identifying the one or more computing devices. For example, computing system 340 may transmit the request to computing device 300A based on identifying computing device 300A via the identifier. Additionally, or alternatively, computing system 340 may transmit the request to computing device 300B based on identifying computing device 300B. By transmitting the request to both computing device 300A and computing device 300B, the chances of computing device 300A receiving the request are increased. For example, if computing device 300A fails to receive the request from computing system 340, computing device 300A may still receive a forwarded request from computing device 300B. In some instances, computing system 340 may transmit the request to a target device based on capabilities of computing device 300A. For instance, computing system 340 may determine, via association repository 342, that computing device 300A is not configured to receive cellular transmissions. However, computing system 340 may determine that computing device 300B is associated with computing device 300A (e.g., is assigned to the same user account and/or is wirelessly connected to computing device 300A via a BLE channel). Based on these determinations, computing system 340 may transmit the request to initiate wireless communication protocol advertisement message broadcasts to computing device 300B, with instructions that computing device 300B forward the request or transmit a substantially similar request to computing device 300A.

Computing device 300A may receive the request to initiate wireless communication protocol advertisement message broadcasts, where the request was transmitted by computing system 340 and/or computing device 300B. Responsive to receiving the request, computing device 300A may transmit an advertisement message broadcast. For instance, computing device 300A may transmit an advertisement message via BLE, the message indicating availability for pairing. In response to receiving the advertisement message broadcast, computing device 300C and/or computing device 300A may initialize a wireless communication channel (e.g., a BLE channel) between computing device 300C and computing device 300A. Computing device 300C and computing device 300A may send and receive information to each other via the communication channel. Although the example provided above is with respect to Bluetooth and BLE communication methods, it is conceived that computing device 300A and computing device 300C may instead advertise and initialize a wireless communication channel via any wireless communication method, e.g., Wi-Fi and cellular communication methods.

An example with respect to FIG. 3 will now be provided. In this example, a central device (e.g., computing device 300C) and peripheral device (e.g., computing device 300A) communicate through a cloud system (e.g., computing system 340). As a pre-condition, the central and the peripheral each register an identity with the cloud system when signing into the cloud system. When the central and peripheral devices are signed in with the same account (e.g., a user account registered at association repository 342), a remote procedure call may be invoked to the cloud system from the central and/or peripheral. The cloud system may check if the devices are registered under the same account before forwarding messages to a targeted device. In one example, the central device triggers a remote procedure call to the cloud system, the remote procedure call including a discoverability request. The cloud system may then forward the discoverability request to the peripheral device. In response to receiving the request, the peripheral device may begin a public connectable BLE advertisement for accepting connections. The central device may connect to the peripheral device based on receiving the advertisement. In some implementations, the discoverability request may indicate the peripheral device, where the cloud system may forward the discoverability request to the peripheral device based on the indication. In still some implementations, the cloud system may forward the discoverability request to all devices associated with a user account indicated by the discoverability request.

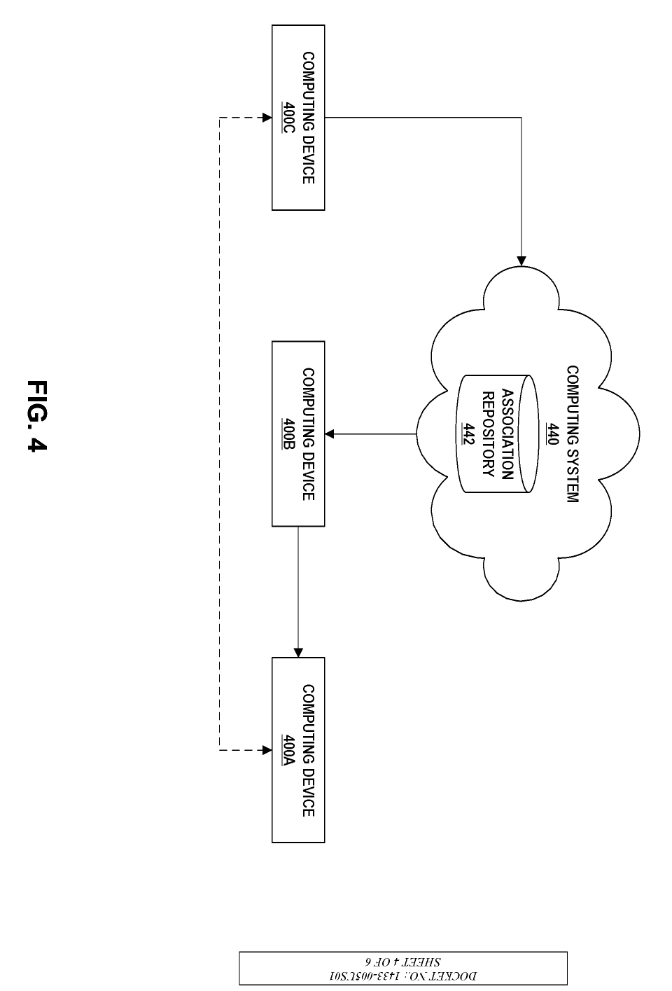

FIG. 4 is a conceptual diagram illustrating an example network of computing elements configured to perform computing system-assisted communication reconnection techniques, in accordance with one or more aspects of this disclosure. In some implementations, computing device 400A may be a peripheral device, computing device 400B may be a companion (or proxy) device, and computing device 400C may be a central device. In some implementations, the techniques described with respect to FIG. 4 may be implemented after computing device 400A and computing device 400C have established a wireless communication channel.

After computing device 400C and computing device 400A have established a wireless communication channel, the wireless communication channel may be disconnected. For example, computing device 400C may be taken beyond a maximum wireless communication channel range of computing device 400A. Responsive to detecting the disconnection of the wireless communication channel between computing device 400C and computing device 400A, computing device 400C may transmit, to computing system 440 (e.g., a cloud system), a reconnection request. The reconnection request may include information indicating computing device 400A. For example, the reconnection request may include a sequence of characters identifying computing device 400A. Additionally, or alternatively, the reconnection request may include account information. For example, the reconnection request may identify a user account stored at association repository 442. In this example, the reconnection request may include a user account identification code, a user password, and/or a username. Computing system 440 may transmit a subsequent reconnection request to computing device 400B based on a determination that computing device 400B is or may be in wireless communication with computing device 400A. The subsequent reconnection request may include instructions and/or an indication that computing device 400B is to initialize the reconnection of computing device 400A and computing device 400C based on determining that a proximity specification is satisfied.

In response to receiving the subsequent reconnection request, computing device 400B may determine whether a distance between computing device 400C and computing device 400A satisfies a proximity specification. For example, computing device 400B may determine whether computing device 400A and computing device 400C are within a close enough distance such that a reinitialization of a wireless communication channel between computing device 400A and computing device 400C is likely to succeed. To determine whether the distance between computing device 400C and computing device 400A satisfies the proximity specification, computing device 400B may determine whether computing device 400C and computing device 400B are connected to the same local network. For example, computing device 400B may determine, based on the subsequent reconnection request, if computing device 400C and computing device 400B are connected to the same Wi-Fi network.

Because computing device 400B is wirelessly connected to computing device 400A, the local network of computing device 400B may indicate a location of computing device 400A. Therefore, computing device 400B may determine that the distance between computing device 400C and computing device 400A satisfies the proximity specification based on determining that computing device 400C and computing device 400B are connected to the same local network. Similarly, computing device 400B may determine that the distance between computing device 400C and computing device 400A does not satisfy the proximity specification based on determining that computing device 400C and computing device 400B are not connected to the same local network.

It is also conceived that computing device 400B may determine whether the distance between computing device 400C and computing device 400A satisfies the proximity specification by comparing local networks available to computing device 400C with local networks available to computing device 400B. For example, the reconnection request and the subsequent reconnection request may include network information associated with computing device 400C, where the network information includes networks available to computing device 400C.

Determining whether the distance between computing device 400C and computing device 400A satisfies the proximity specification may be based on the network information. For instance, if the same local network (e.g., Wi-Fi source or Bluetooth source) is available to both computing device 400C and computing device 400B, computing device 400B may determine that the distance between computing device 400C and computing device 400A satisfies the proximity specification. If computing device 400C and computing device 400B share no available local networks, computing device 400B may determine that the distance between computing device 400C and computing device 400A does not satisfy the proximity specification. Similarly, in some implementations, if computing device 400C and computing device 400B are connected to the same local network, computing device 400B may determine that the distance between computing device 400C and computing device 400A satisfies the proximity specification. If computing device 400C and computing device 400B are not connected to the same local network, computing device 400B may determine that the distance between computing device 400C and computing device 400A does not satisfy the proximity specification. In response to determining that the distance does not satisfy the proximity specification, computing device 400B may transmit, to computing device 400A, a request to stop wireless communication protocol advertisement message broadcasts. Computing device 400A may stop transmitting wireless communication protocol advertisement message broadcasts based on receiving the request.

Responsive to determining that the distance between computing device 400C and computing device 400A satisfies the proximity specification, computing device 400B may transmit, to computing device 400A, a request to reinitiate wireless communication protocol advertisement message broadcasts. In response to receiving the request, computing device 400A may transmit a subsequent advertisement message broadcast (e.g., a BLE advertisement). Responsive to receiving the subsequent advertisement message broadcast, computing device 400C may initialize a subsequent wireless communication channel between computing device 400C and computing device 400A. In some implementations, the subsequent wireless communication channel may be a reinitialized wireless communication channel. Although the examples described with respect to FIG. 4 disclose techniques for reconnecting computing device 400A and computing device 400C responsive to a disconnection, it is conceived that the same techniques may be used to connect computing device 400A and computing device 400C regardless of a previous connection between computing device 400A and computing device 400C.

An example with respect to FIG. 4 will now be described. In this example, a companion device (e.g. computing device 400B) acts as a proxy signal for a peripheral device (e.g., computing device 400A). The companion device is paired to the peripheral device during setup when a user first unboxes the peripheral device. Thereafter, the peripheral device and the companion device maintain a co-presence as long as the peripheral and companion devices are powered and near each other. In this example, the companion device and the peripheral device are often connected and near each other and the companion device has a larger battery capacity than the peripheral device. The companion device may be a smartphone, and the peripheral device may be a smartwatch.

In response to a disconnection between the peripheral device and a central device (e.g., computing device 400C), the peripheral device may advertise via BLE. The central device may transmit network information including a Service Set Identifier (SSID) and/or a Basic Service Set Identifier (BSSID) to the companion device via a cloud system (e.g., computing system 440). The central device may transmit the network information at the time of BLE disconnection or if the network information changes (e.g., the central device connected to a different Wi-Fi SSID or BSSID) when the central device had previously disconnected from the peripheral device. In response to receiving the network information from the cloud system, the companion device may compare the network information with a network scan result to determine a proximity to the central device. If the central device is determined to be outside of Bluetooth range of the companion and/or peripheral devices, the companion device may trigger the peripheral device to stop advertising. If the central device is determined to be within Bluetooth range of the companion and/or peripheral devices, the companion device may trigger the peripheral device to start advertising or continue advertising. If the companion device does not receive a signal (e.g., network information) from the cloud system, the companion device may, as a fallback, allow the peripheral device to continue advertising.

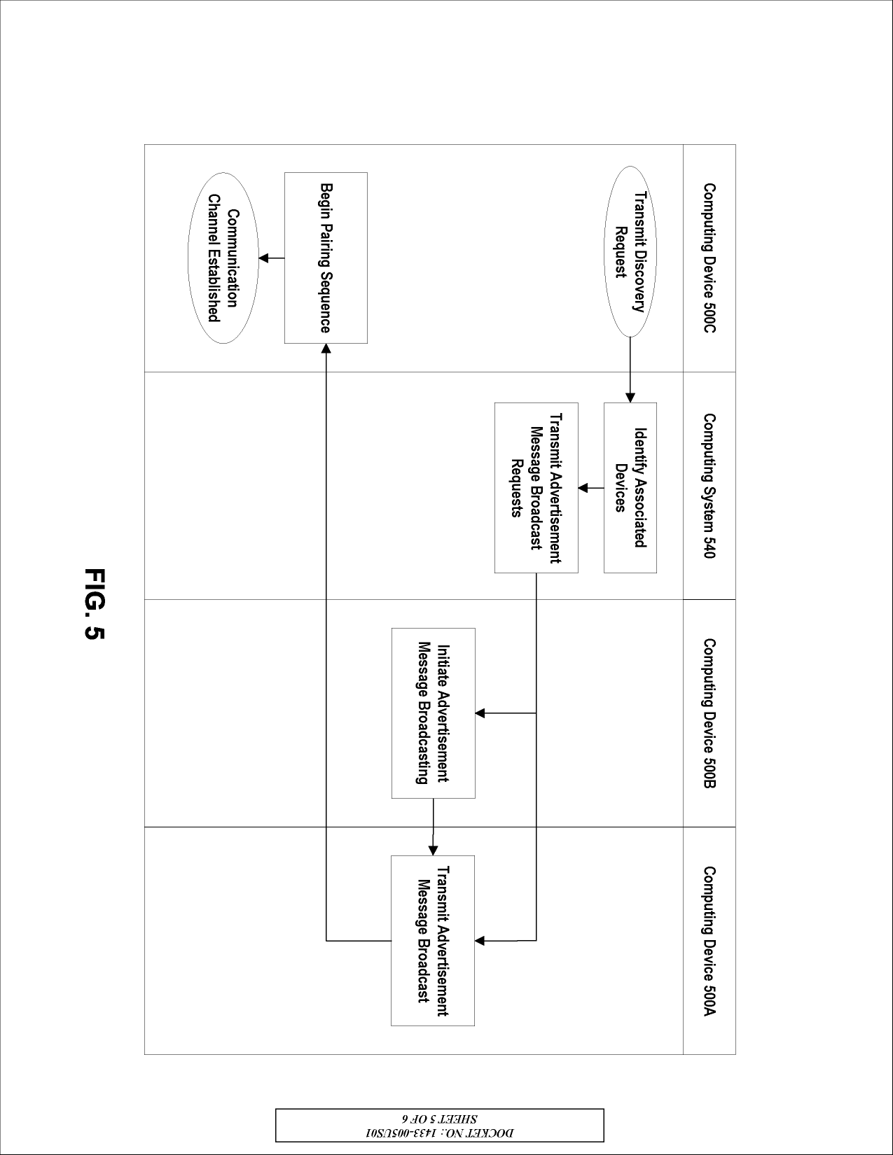

FIG. 5 is a swimlane diagram illustrating an example operation for establishing a wireless communication channel, in accordance with one or more aspects of this disclosure. As shown in FIG. 5, computing device 500C may transmit a discovery request to computing system 540. In some implementations, the discovery request may include an identifier. The identifier may be associated with a user account. For example, the identifier may include account information, e.g., a username, email address, or account identification code. Additionally, or alternatively, the identifier may be associated with a source device, e.g., computing device 500C. For instance, the identifier may identify computing device 500C via a device identification code. Furthermore, the identifier may be associated with a destination device, e.g., the identifier may identify computing device 500B and/or computing device 500A.

In response to receiving the discovery request, computing system 540 may identify a set of devices associated with the discovery request based on the identifier. As discussed with respect to FIG. 3, computing system 540 may identify the set of devices based on account information received via the discovery request, where the set of devices is associated with the account. For example, a user may create a user account and may register one or more devices to the user account. In this example, the account information may identify the user account, and the set of devices may include the one or more devices registered to the user account. In some implementations, the discovery request may identify, via the identifier, one or more destination devices. Computing system 540 may identify the set of devices based on the identified destination devices, e.g., the set of devices may be the identified destination devices. It is also conceived that computing system 540 may identify the set of devices based additionally on the capabilities of the device(s) associated with the discovery request, a connection status of the device(s) associated with the discovery request (e.g., whether one of the devices is wirelessly connected to another of the devices), and/or a connection viability of the device(s) (e.g., whether the device(s) may wirelessly connect to computing device 500C).

Computing system 540 may transmit advertisement message requests (e.g., a request to initiate wireless communication protocol advertisement message broadcasts) to one or more of the set of identified devices. In the example illustrated with respect to FIG. 5, the set of identified devices may be computing device 500A and computing device 500B, where computing device 500A may be identified based on being associated with a user account and computing device 500B may be identified based on being associated with the user account and/or being wirelessly connected to computing device 500A. In some implementations, computing system 540 may transmit advertisement message requests to a subset of the set of identified devices. For example, computing system 540 may transmit a request to only computing device 500A or only computing device 500B.

In response to receiving an advertisement message request, computing device 500B may initiate advertisement message broadcasting at computing device 500A. For example, computing device 500B may transmit instructions to computing device 500A, where the instructions cause computing device 500A to transmit advertisement message broadcasts. Responsive to receiving the instructions or receiving an advertisement message request, computing device 500A may begin transmitting advertisement message broadcasts.

In response to receiving an advertisement message from computing device 500A, computing device 500C may begin a pairing sequence with computing device 500A. For example, computing device 500C may initiate a connection request using information provided by the advertisement message, e.g., a device identifier, security credentials, and/or supported communication protocols. Responsive to receiving the connection request, computing device 500A may respond by authenticating computing device 500C using pairing techniques including exchanging encryption keys, verifying a shared passcode, and/or implementing out-of-band authentication methods. After authentication, computing device 500C and computing device 500A may establish a wireless communication channel. The channel may enable encrypted data exchange, enabling computing device 500C and computing device 500A to securely transmit messages, synchronize information, and/or execute collaborative tasks.

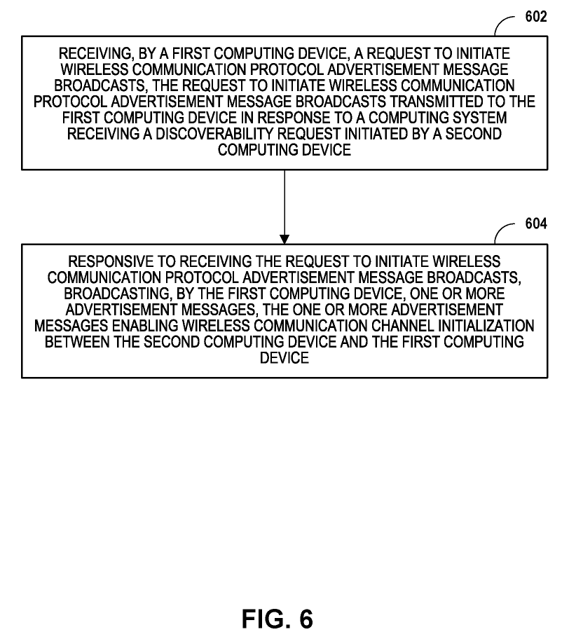

FIG. 6 is a flowchart illustrating an example operation for establishing a wireless communication channel, in accordance with one or more aspects of this disclosure. The example of FIG. 6 is described with respect to FIG. 1. In some implementations, a technique for establishing a wireless communication channel may include receiving, by a first computing device, a request to initiate wireless communication protocol advertisement message broadcasts, where the request to initiate wireless communication protocol advertisement message broadcasts is transmitted to the first computing device in response to a computing system receiving a discoverability request initiated by a second computing device (602). For example, computing device 100C may transmit a discoverability request to computing system 140 via a remote procedure call, where the discoverability request includes an identifier associated with computing device 100A. Computing system 140 may then transmit a request to initiate wireless communication protocol advertisement message broadcasts to computing device 100A. Additionally, or alternatively, computing system 140 may transmit a request to initiate wireless communication protocol advertisement message broadcasts to computing device 100B based on determining that computing device 100B is linked to the same user account as computing device 100A. The request may identify computing device 100A. In response to receiving the request, computing device 100B may transmit a request to initiate wireless communication protocol advertisement message broadcasts to computing device 100A.

The technique may also include, responsive to receiving the request to initiate wireless communication protocol advertisement message broadcasts, broadcasting, by the first computing device, one or more advertisement messages, the one or more advertisement messages enabling wireless communication channel initialization between the second computing device and the first computing device (604). For example, after receiving an advertisement message, computing device 100A and computing device 100C may initiate a Bluetooth pairing or bonding sequence. Computing device 100A may then wirelessly communicate with computing device 100C using a Bluetooth communication channel established via the pairing or bonding sequence.

As discussed, various techniques of the present disclosure may include collecting or processing user information. According to various aspects of the present disclosure, a user may be provided with controls allowing the user to make an election as to both if and when systems, programs, or features described herein may enable collection of user information (e.g., information about a user’s social network, account, social actions, or activities, profession, a user’s preferences, or a user’s current location), and if the user is sent content or communications from a cloud system (e.g., computing system 140). In addition, certain data may be treated in one or more ways before it is stored or used, so that personally identifiable information is removed. For example, a user’s identity may be processed by computing device 100C so that no personally identifiable information can be determined for the user, or a user’s geographic location may be generalized where location information is obtained (such as to a city, ZIP code, or state level), so that a particular location of a user cannot be determined. Thus, the user may have control over what information is collected about the user, how that information is used, and what information is provided to the user.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium, e.g., data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium, e.g., a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise random-access memory, read-only memory, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line, or wireless technologies, e.g., infrared, radio, and microwave, then the coaxial cable, fiber optic cable, twisted pair, DSL, or wireless technologies, e.g., infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, include compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, e.g., one or more digital signal processors, general purpose microprocessors, application specific integrated circuits, field programmable logic arrays, or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit or a set of integrated circuits (e.g., a chip set). Various components, modules, or units are described in this disclosure to emphasize functional aspects of devices configured to perform the disclosed techniques, but do not necessarily require realization by different hardware units. Rather, various units may be combined in a hardware unit or provided by a collection of interoperative hardware units, including one or more processors, in conjunction with suitable software and/or firmware.

It is to be recognized that, depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in random-access memory or cache).

Example 1: A method includes receiving, by a first computing device, a request to initiate wireless communication protocol advertisement message broadcasts, the request to initiate wireless communication protocol advertisement message broadcasts transmitted to the first computing device in response to a computing system receiving a discoverability request initiated by a second computing device; and responsive to receiving the request to initiate wireless communication protocol advertisement message broadcasts, broadcasting, by the first computing device, one or more advertisement messages, the one or more advertisement messages enabling wireless communication channel initialization between the second computing device and the first computing device.

Example 2: The method of example 1, further including receiving, by the first computing device, a request to reinitiate wireless communication protocol advertisement message broadcasts, the request to reinitiate wireless communication protocol advertisement message broadcasts transmitted by a third computing device (which may be a relay device) based on the third computing device receiving a reconnection request associated with the first computing device and determining that a distance between the first computing device and the second computing device satisfies a proximity specification; and responsive to receiving the request to reinitiate wireless communication protocol advertisement message broadcasts, transmitting, by the first computing device, a subsequent advertisement message broadcast, the subsequent advertisement message broadcast enabling wireless communication channel initialization between the second computing device and the first computing device.

Example 3: The method of example 2, further including receiving, by the first computing device, a request to stop wireless communication protocol advertisement message broadcasts, the request to stop wireless communication protocol advertisement message broadcasts transmitted by the third computing device based on the third computing device determining that the distance between the first computing device and the second computing device exceeds a proximity threshold.

Example 4: The method of any of examples 2 and 3, wherein the request to reinitiate wireless communication protocol advertisement message broadcasts is transmitted by the third computing device based on network information associated with the second computing device.

Example 5: The method of any of examples 2 through 4, wherein the request to reinitiate wireless communication protocol advertisement message broadcasts is transmitted by the third computing device in response to determining that the second computing device and the third computing device are connected to a same local network.

Example 6: The method of any of examples 2 through 5, wherein the request to reinitiate wireless communication protocol advertisement message broadcasts is transmitted by the third computing device based on comparing location information of the second computing device with location information of the third computing device.

Example 7: The method of any of examples 1 through 6, further including receiving, by the first computing device and from a third computing device, an escalation indication, the escalation indication transmitted based on determining that the third computing device has moved; and responsive to receiving the escalation indication, decreasing, by the first computing device, an advertisement message broadcast interval or increasing, by the first computing device, an advertisement message broadcast power.

Example 8: The method of any of examples 1 through 7, further including, responsive to determining that a duration since transmitting the one or more advertisement messages exceeds a first duration threshold, increasing, by the first computing device, an advertisement message broadcast interval or decreasing, by the first computing device, an advertisement message broadcast power.

Example 9: The method of example 8, further including, responsive to determining that the duration since transmitting the one or more advertisement messages exceeds a second duration threshold, increasing, by the first computing device, the advertisement message broadcast interval or decreasing, by the first computing device, the advertisement message broadcast power.

Example 10: The method of any of examples 1 through 9, wherein the one or more advertisement messages enable wireless communication channel initialization via a Bluetooth Low Energy communication channel.

Example 11: The method of any of examples 1 through 10, wherein the request to initiate wireless communication protocol advertisement message broadcasts is transmitted to the first computing device in response to the computing system determining that a set of computing devices is associated with the second computing device based on a user account, the set of computing devices including at least a third computing device.

Example 12: The method of any of examples 1 through 11, wherein the request to initiate wireless communication protocol advertisement message broadcasts is transmitted to the first computing device based on the discoverability request including an identifier associated with the first computing device.

Example 13: The method of any of examples 1 through 12, further including registering, by the first computing device, an account identity with the computing system by at least transmitting first account information to the computing system, wherein the second computing device has registered the account identity with the computing system by at least transmitting second account information to the computing system.

Example 14: The method of any of examples 1 through 13, wherein the computing system receives the discoverability request from the second computing device via remote procedure call.

Example 15: A first computing device includes one or more processors; and one or more storage devices storing instructions that, when executed by the one or more processors, cause the one or more processors to: receive, at the first computing device, a request to initiate wireless communication protocol advertisement message broadcasts, the request to initiate wireless communication protocol advertisement message broadcasts transmitted to the first computing device in response to a computing system receiving a discoverability request initiated by a second computing device; and responsive to receiving the request to initiate wireless communication protocol advertisement message broadcasts, broadcast, from the first computing device, one or more advertisement messages, the one or more advertisement messages enabling wireless communication channel initialization between the second computing device and the first computing device.

Example 16: The first computing device of example 15, wherein the instructions further cause the one or more processors to: receive, at the first computing device, a request to reinitiate wireless communication protocol advertisement message broadcasts, the request to reinitiate wireless communication protocol advertisement message broadcasts transmitted by a third computing device based on the third computing device receiving a reconnection request associated with the first computing device and determining that a distance between the first computing device and the second computing device satisfies a proximity specification; and responsive to receiving the request to reinitiate wireless communication protocol advertisement message broadcasts, transmit, from the first computing device, a subsequent advertisement message broadcast, the subsequent advertisement message broadcast enabling wireless communication channel initialization between the second computing device and the first computing device.

Example 17: The first computing device of example 16, wherein the instructions further cause the one or more processors to receive, at the first computing device, a request to stop wireless communication protocol advertisement message broadcasts, the request to stop wireless communication protocol advertisement message broadcasts transmitted by the third computing device based on the third computing device determining that the distance between the first computing device and the second computing device exceeds a proximity threshold.

Example 18: The first computing device of any of examples 16 and 17, wherein the request to reinitiate wireless communication protocol advertisement message broadcasts is transmitted by the third computing device based on network information associated with the second computing device.

Example 19: The first computing device of any of examples 16 through 18, wherein the request to reinitiate wireless communication protocol advertisement message broadcasts is transmitted by the third computing device in response to determining that the second computing device and the third computing device are connected to a same local network.

Example 20: The first computing device of any of examples 16 through 19, wherein the request to reinitiate wireless communication protocol advertisement message broadcasts is transmitted by the third computing device based on comparing location information of the second computing device with location information of the third computing device.

Example 21: The first computing device of any of examples 15 through 20, wherein the instructions further cause the one or more processors to: receive, at the first computing device and from a third computing device, an escalation indication, the escalation indication transmitted based on determining that the third computing device has moved; and responsive to receiving the escalation indication, decrease, by the first computing device, an advertisement message broadcast interval or increase, by the first computing device, an advertisement message broadcast power.

Example 22: The first computing device of any of examples 15 through 21, wherein the instructions further cause the one or more processors to, responsive to determining that a duration since transmitting the one or more advertisement messages exceeds a first duration threshold, increase, by the first computing device, an advertisement message broadcast interval or decrease, by the first computing device, an advertisement message broadcast power.

Example 23: The first computing device of example 22, wherein the instructions further cause the one or more processors to, responsive to determining that the duration since transmitting the one or more advertisement messages exceeds a second duration threshold, increase, by the first computing device, the advertisement message broadcast interval or decrease, by the first computing device, the advertisement message broadcast power.

Example 24: The first computing device of any of examples 15 through 23, wherein the one or more advertisement messages enable wireless communication channel initialization via a Bluetooth Low Energy communication channel.

Example 25: The first computing device of any of examples 15 through 24, wherein the request to initiate wireless communication protocol advertisement message broadcasts is transmitted to the first computing device in response to the computing system determining that a set of computing devices is associated with the second computing device based on a user account, the set of computing devices including at least a third computing device.

Example 26: The first computing device of any of examples 15 through 25, wherein the request to initiate wireless communication protocol advertisement message broadcasts is transmitted to the first computing device based on the discoverability request including an identifier associated with the first computing device.

Example 27: The first computing device of any of examples 15 through 26, wherein the instructions further cause the one or more processors to register, by the first computing device, an account identity with the computing system by at least transmitting first account information to the computing system, wherein the second computing device has registered the account identity with the computing system by at least transmitting second account information to the computing system.

Example 28: The first computing device of any of examples 15 through 27, wherein the computing system receives the discoverability request from the second computing device via remote procedure call.

Example 29: A non-transitory computer-readable storage medium encoded with instructions that, when executed by one or more processors of a first computing device, cause the one or more processors to: receive, at the first computing device, a request to initiate wireless communication protocol advertisement message broadcasts, the request to initiate wireless communication protocol advertisement message broadcasts transmitted to the first computing device in response to a computing system receiving a discoverability request initiated by a second computing device; and responsive to receiving the request to initiate wireless communication protocol advertisement message broadcasts, broadcast, from the first computing device, one or more advertisement messages, the one or more advertisement messages enabling wireless communication channel initialization between the second computing device and the first computing device.

Example 30: The non-transitory computer-readable storage medium of example 29, wherein the one or more processors further execute the instructions to: receive, at the first computing device, a request to reinitiate wireless communication protocol advertisement message broadcasts, the request to reinitiate wireless communication protocol advertisement message broadcasts transmitted by a third computing device based on the third computing device receiving a reconnection request associated with the first computing device and determining that a distance between the first computing device and the second computing device satisfies a proximity specification; and responsive to receiving the request to reinitiate wireless communication protocol advertisement message broadcasts, transmit, from the first computing device, a subsequent advertisement message broadcast, the subsequent advertisement message broadcast enabling wireless communication channel initialization between the second computing device and the first computing device.

Example 31: The non-transitory computer-readable storage medium of example 30, wherein the one or more processors further execute the instructions to receive, at the first computing device, a request to stop wireless communication protocol advertisement message broadcasts, the request to stop wireless communication protocol advertisement message broadcasts transmitted by the third computing device based on the third computing device determining that the distance between the first computing device and the second computing device exceeds a proximity threshold.

Example 32: The non-transitory computer-readable storage medium of any of examples 30 and 31, wherein the request to reinitiate wireless communication protocol advertisement message broadcasts is transmitted by the third computing device based on network information associated with the second computing device.

Example 33: The non-transitory computer-readable storage medium of any of examples 30 through 32, wherein the request to reinitiate wireless communication protocol advertisement message broadcasts is transmitted by the third computing device in response to determining that the second computing device and the third computing device are connected to a same local network.

Example 34: The non-transitory computer-readable storage medium of any of examples 30 through 33, wherein the request to reinitiate wireless communication protocol advertisement message broadcasts is transmitted by the third computing device based on comparing location information of the second computing device with location information of the third computing device.

Example 35: The non-transitory computer-readable storage medium of any of examples 29 through 34, wherein the one or more processors further execute the instructions to: receive, at the first computing device and from a third computing device, an escalation indication, the escalation indication transmitted based on determining that the third computing device has moved; and responsive to receiving the escalation indication, decrease, by the first computing device, an advertisement message broadcast interval or increase, by the first computing device, an advertisement message broadcast power.

Example 36: The non-transitory computer-readable storage medium of any of examples 29 through 35, wherein the one or more processors further execute the instructions to, responsive to determining that a duration since transmitting the one or more advertisement messages exceeds a first duration threshold, increase, by the first computing device, an advertisement message broadcast interval or decrease, by the first computing device, an advertisement message broadcast power.

Example 37: The non-transitory computer-readable storage medium of any of examples 22 through 36, wherein the one or more processors further execute the instructions to, responsive to determining that the duration since transmitting the one or more advertisement messages exceeds a second duration threshold, increase, by the first computing device, the advertisement message broadcast interval or decrease, by the first computing device, the advertisement message broadcast power.

Example 38: The non-transitory computer-readable storage medium of any of examples 29 through 37, wherein the one or more advertisement messages enable wireless communication channel initialization via a Bluetooth Low Energy communication channel.

Example 39: The non-transitory computer-readable storage medium of any of examples 29 through 38, wherein the request to initiate wireless communication protocol advertisement message broadcasts is transmitted to the first computing device in response to the computing system determining that a set of computing devices is associated with the second computing device based on a user account, the set of computing devices including at least a third computing device.

Example 40: The non-transitory computer-readable storage medium of any of examples 29 through 39, wherein the request to initiate wireless communication protocol advertisement message broadcasts is transmitted to the first computing device based on the discoverability request including an identifier associated with the first computing device.

Example 41: The non-transitory computer-readable storage medium of any of examples 29 through 40, wherein the one or more processors further execute the instructions to register, by the first computing device, an account identity with the computing system by at least transmitting first account information to the computing system, wherein the second computing device has registered the account identity with the computing system by at least transmitting second account information to the computing system.

Example 42: The non-transitory computer-readable storage medium of any of examples 29 through 41, wherein the computing system receives the discoverability request from the second computing device via remote procedure call.

Example 43: A computing system comprising means for performing any combination of examples 1 through 14.

Example 44: A computer program product comprising one or more instructions that, when executed by a computing system, cause the computing system to perform any combination of examples 1 through 14.

Example 45: A computing system includes a first computing device; a second computing device; one or more processors; and one or more storage devices storing instructions that, when executed by the one or more processors, cause the one or more processors to: receive, at the second computing device, a request to initiate wireless communication protocol advertisement message broadcasts, the request to initiate wireless communication protocol advertisement message broadcasts transmitted by a cloud system or a third computing device wirelessly connected to the second computing device, wherein the cloud system initiated the request to initiate wireless communication protocol advertisement message broadcasts based on identifying the second computing device or third computing device; responsive to receiving the request to initiate wireless communication protocol advertisement message broadcasts, transmit, from the second computing device, an advertisement message broadcast; and responsive to receiving the advertisement message broadcast at the first computing device, initialize a wireless communication channel between the first computing device and second computing device.

Example 46: The computing system of example 45, wherein the instructions further cause the one or more processors to: determine, by the third computing device, whether a distance between the first computing device and the second computing device satisfies a proximity specification; responsive to determining that the distance satisfies the proximity specification, transmit, by the third computing device and to the second computing device, a request to reinitiate wireless communication protocol advertisement message broadcasts; responsive to receiving the request to reinitiate wireless communication protocol advertisement message broadcasts, transmit, by the second computing device, a subsequent advertisement message broadcast; and responsive to receiving the subsequent advertisement message broadcast, initialize, by the first computing device, a subsequent wireless communication channel between the first computing device and second computing device.

Example 47: The computing system of example 46, wherein the instructions further cause the one or more processors to, responsive to detecting a disconnection of the wireless communication channel between the first computing device and second computing device, transmit, by the first computing device and to the cloud system, a reconnection request indicating the second computing device, wherein: the cloud system transmits a subsequent reconnection request based on the reconnection request; and determining whether the distance between the first computing device and the second computing device satisfies the proximity specification is based on receiving the subsequent reconnection request.

Example 48: The computing system of example 47, wherein: the reconnection request and the subsequent reconnection request include network information associated with the first computing device; and determining whether the distance between the first computing device and the second computing device satisfies the proximity specification is based on the network information.

Example 49: The computing system of any of examples 46 and 47, wherein the instructions further cause the one or more processors to, responsive to determining that the distance does not satisfy the proximity specification, transmit, by the third computing device and to the second computing device, a request to stop wireless communication protocol advertisement message broadcasts.

Example 50: A method includes receiving, by a second computing device, a request to initiate wireless communication protocol advertisement message broadcasts, the request to initiate wireless communication protocol advertisement message broadcasts transmitted by a cloud system or a third computing device wirelessly connected to the second computing device, wherein the cloud system initiated the request to initiate wireless communication protocol advertisement message broadcasts based on identifying the second computing device or third computing device; responsive to receiving the request to initiate wireless communication protocol advertisement message broadcasts, transmitting, by the second computing device, an advertisement message broadcast; and responsive to receiving the advertisement message broadcast at the first computing device, initializing a wireless communication channel between the first computing device and second computing device.

Example 51: The method of example 50, further including determining, by the third computing device, whether a distance between the first computing device and the second computing device satisfies a proximity specification; responsive to determining that the distance satisfies the proximity specification, transmitting, by the third computing device and to the second computing device, a request to reinitiate wireless communication protocol advertisement message broadcasts; responsive to receiving the request to reinitiate wireless communication protocol advertisement message broadcasts, transmitting, by the second computing device, a subsequent advertisement message broadcast; and responsive to receiving the subsequent advertisement message broadcast, initializing, by the first computing device, a subsequent wireless communication channel between the first computing device and second computing device.

Example 52: The method of example 51, further including the cloud system transmits a subsequent reconnection request based on the reconnection request; and determining whether the distance between the first computing device and the second computing device satisfies the proximity specification is based on receiving the subsequent reconnection request.

Example 53: The method of example 52, wherein: the reconnection request and the subsequent reconnection request include network information associated with the first computing device; and determining whether the distance between the first computing device and the second computing device satisfies the proximity specification is based on the network information.

Example 54: The method of any of examples 51 and 52, further including, responsive to determining that the distance does not satisfy the proximity specification, transmit, by the third computing device and to the second computing device, a request to stop wireless communication protocol advertisement message broadcasts.

Example 55: A non-transitory computer-readable storage medium encoded with instructions that, when executed by one or more processors of a first computing device, cause the one or more processors to: receive, by a second computing device, a request to initiate wireless communication protocol advertisement message broadcasts, the request to initiate wireless communication protocol advertisement message broadcasts transmitted by a cloud system or a third computing device wirelessly connected to the second computing device, wherein the cloud system initiated the request to initiate wireless communication protocol advertisement message broadcasts based on identifying the second computing device or third computing device; responsive to receiving the request to initiate wireless communication protocol advertisement message broadcasts, transmit, by the second computing device, an advertisement message broadcast; and responsive to receiving the advertisement message broadcast at the first computing device, initialize a wireless communication channel between the first computing device and second computing device.

Example 56: The non-transitory computer-readable storage medium of example 55, wherein the one or more processors further execute the instructions to: determine, by the third computing device, whether a distance between the first computing device and the second computing device satisfies a proximity specification; responsive to determining that the distance satisfies the proximity specification, transmit, by the third computing device and to the second computing device, a request to reinitiate wireless communication protocol advertisement message broadcasts; responsive to receiving the request to reinitiate wireless communication protocol advertisement message broadcasts, transmit, by the second computing device, a subsequent advertisement message broadcast; and responsive to receiving the subsequent advertisement message broadcast, initialize, by the first computing device, a subsequent wireless communication channel between the first computing device and second computing device.

Example 57: The non-transitory computer-readable storage medium of example 56, wherein the one or more processors further execute the instructions to, responsive to detecting a disconnection of the wireless communication channel between the first computing device and second computing device, transmit, by the first computing device and to the cloud system, a reconnection request indicating the second computing device, wherein: the cloud system transmits a subsequent reconnection request based on the reconnection request; and determining whether the distance between the first computing device and the second computing device satisfies the proximity specification is based on receiving the subsequent reconnection request.

Example 58: The non-transitory computer-readable storage medium of example 57, wherein: the reconnection request and the subsequent reconnection request include network information associated with the first computing device; and determining whether the distance between the first computing device and the second computing device satisfies the proximity specification is based on the network information.

Example 59: The non-transitory computer-readable storage medium of any of examples 56 and 57, wherein the one or more processors further execute the instructions to, responsive to determining that the distance does not satisfy the proximity specification, transmit, by the third computing device and to the second computing device, a request to stop wireless communication protocol advertisement message broadcasts.

Example 60: A computing system comprising means for performing any combination of examples 50 through 54.

Example 61: A computer program product comprising one or more instructions that, when executed by a computing system, cause the computing system to perform any combination of examples 50 through 54.

What is claimed is:

1. A method comprising:
receiving, by a first computing device, a request to initiate wireless communication protocol advertisement message broadcasts, the request to initiate wireless communication protocol advertisement message broadcasts transmitted to the first computing device in response to a computing system receiving a discoverability request initiated by a second computing device; and
responsive to receiving the request to initiate wireless communication protocol advertisement message broadcasts, broadcasting, by the first computing device, one or more advertisement messages, the one or more advertisement messages enabling wireless communication channel initialization between the second computing device and the first computing device.

2. The method of claim 1, further comprising:
receiving, by the first computing device, a request to reinitiate wireless communication protocol advertisement message broadcasts, the request to reinitiate wireless communication protocol advertisement message broadcasts transmitted by a third computing device based on the third computing device receiving a reconnection request associated with the first computing device and determining that a distance between the first computing device and the second computing device satisfies a proximity specification; and
responsive to receiving the request to reinitiate wireless communication protocol advertisement message broadcasts, transmitting, by the first computing device, a subsequent advertisement message broadcast, the subsequent advertisement message broadcast enabling wireless communication channel initialization between the second computing device and the first computing device.

3. The method of claim 2, further comprising: receiving, by the first computing device, a request to stop wireless communication protocol advertisement message broadcasts, the request to stop wireless communication protocol advertisement message broadcasts transmitted by the third computing device based on the third computing device determining that the distance between the first computing device and the second computing device exceeds a proximity threshold.

4. The method of claim 2, wherein the request to reinitiate wireless communication protocol advertisement message broadcasts is transmitted by the third computing device based on network information associated with the second computing device.

5. The method of claim 2, wherein the request to reinitiate wireless communication protocol advertisement message broadcasts is transmitted by the third computing device in response to determining that the second computing device and the third computing device are connected to a same local network.

6. The method of claim 2, wherein the request to reinitiate wireless communication protocol advertisement message broadcasts is transmitted by the third computing device based on comparing location information of the second computing device with location information of the third computing device.

7. The method of claim 1, further comprising:
receiving, by the first computing device and from a third computing device, an escalation indication, the escalation indication transmitted based on determining that the third computing device has moved; and
responsive to receiving the escalation indication, decreasing, by the first computing device, an advertisement message broadcast interval or increasing, by the first computing device, an advertisement message broadcast power.

8. The method of claim 1, further comprising, responsive to determining that a duration since transmitting the one or more advertisement messages exceeds a first duration threshold, increasing, by the first computing device, an advertisement message broadcast interval or decreasing, by the first computing device, an advertisement message broadcast power.

9. The method of claim 8, further comprising, responsive to determining that the duration since transmitting the one or more advertisement messages exceeds a second duration threshold, increasing, by the first computing device, the advertisement message broadcast interval or decreasing, by the first computing device, the advertisement message broadcast power.

10. The method of claim 1, wherein the one or more advertisement messages enable wireless communication channel initialization via a Bluetooth Low Energy communication channel.

11. The method of claim 1, wherein the request to initiate wireless communication protocol advertisement message broadcasts is transmitted to the first computing device in response to the computing system determining that a set of computing devices is associated with the second computing device based on a user account, the set of computing devices including at least a third computing device.

12. The method of claim 1, wherein the request to initiate wireless communication protocol advertisement message broadcasts is transmitted to the first computing device based on the discoverability request including an identifier associated with the first computing device.

13. The method of claim 1, further comprising registering, by the first computing device, an account identity with the computing system by at least transmitting first account information to the computing system, wherein the second computing device has registered the account identity with the computing system by at least transmitting second account information to the computing system.

14. The method of claim 1, wherein the computing system receives the discoverability request from the second computing device via remote procedure call.

15. A first computing device comprising:
one or more processors; and
one or more storage devices storing instructions that, when executed by the one or more processors, cause the one or more processors to:
receive, at the first computing device, a request to initiate wireless communication protocol advertisement message broadcasts, the request to initiate wireless communication protocol advertisement message broadcasts transmitted to the first computing device in response to a computing system receiving a discoverability request initiated by a second computing device; and
responsive to receiving the request to initiate wireless communication protocol advertisement message broadcasts, broadcast, from the first computing device, one or more advertisement messages, the one or more advertisement messages enabling wireless communication channel initialization between the second computing device and the first computing device.

16. The first computing device of claim 15, wherein the instructions further cause the one or more processors to:
receive, at the first computing device, a request to reinitiate wireless communication protocol advertisement message broadcasts, the request to reinitiate wireless communication protocol advertisement message broadcasts transmitted by a third computing device based on the third computing device receiving a reconnection request associated with the first computing device and determining that a distance between the first computing device and the second computing device satisfies a proximity specification; and
responsive to receiving the request to reinitiate wireless communication protocol advertisement message broadcasts, transmit, from the first computing device, a subsequent advertisement message broadcast, the subsequent advertisement message broadcast enabling wireless communication channel initialization between the second computing device and the first computing device.

17. The first computing device of claim 16, wherein the request to reinitiate wireless communication protocol advertisement message broadcasts is transmitted by the third computing device in response to determining that the second computing device and the third computing device are connected to a same local network.

18. The first computing device of claim 15, wherein the instructions further cause the one or more processors to:
receive, at the first computing device and from a third computing device, an escalation indication, the escalation indication transmitted based on determining that the third computing device has moved; and
responsive to receiving the escalation indication, decrease, by the first computing device, an advertisement message broadcast interval or increase, by the first computing device, an advertisement message broadcast power.

19. The first computing device of claim 15, wherein the instructions further cause the one or more processors to register, by the first computing device, an account identity with the computing system by at least transmitting first account information to the computing system, wherein the second computing device has registered the account identity with the computing system by at least transmitting second account information to the computing system.

20. A non-transitory computer-readable storage medium encoded with instructions that, when executed by one or more processors of a first computing device, cause the one or more processors to:
receive, at the first computing device, a request to initiate wireless communication protocol advertisement message broadcasts, the request to initiate wireless communication protocol advertisement message broadcasts transmitted to the first computing device in response to a computing system receiving a discoverability request initiated by a second computing device; and
responsive to receiving the request to initiate wireless communication protocol advertisement message broadcasts, broadcast, at the first computing device, one or more advertisement messages, the one or more advertisement messages enabling wireless communication channel initialization between the second computing device and the first computing device.
